(19) United States
(12) Patent Application Publication
(10) Pub. No.: US 2011/0233131 A1
(43) Pub. Date: Sep. 29, 2011

(54) FILTERING AND CONDENSING APPARATUS OF SUCTION TYPE

(75) Inventors: Masamitsu Fujisaki, Tokyo (JP); Hideyuki Oohanamori, Tokyo (JP); Tadashi Kunitani, Tokyo (JP)

(73) Assignee: METAWATER Co., Ltd., Minato-ku, Tokyo (JP)

(21) Appl. No.: 12/442,394

(22) PCT Filed: Feb. 19, 2009
(86) PCT No.: PCT/JP2009/000701

§ 371 Date: May 9, 2011

(30) Foreign Application Priority Data
Sep. 25, 2008 (JP) 2008-246165

(51) Int. Cl. B01D 33/35

(52) U.S. Cl. 210/350

(57) ABSTRACT

An object of the present invention is, in a case where a filtering and condensing apparatus of a suction type is upsized, to provide such an apparatus which is capable of securing an integrity of a filtering cloth, while at the same time of preventing a lower portion of the filtering cloth from being slackened by maintaining the vertical tension force applied to the filtering cloth to be substantially constant.

A filtering and condensing apparatus of a suction type comprises a sludge tank for containing sludge to be filtered and condensed, and a plurality of filtering plates aligned with each other so as to be disposed to be adjacent to each other in the sludge tank. Each plane portion of the filtering plate extends in the vertical direction. Each of the filtering plates includes a supporting plate in the form of a net, and a filtering cloth in a bag form so as to be integrally sewed on the supporting plate and to house the supporting plate, whereby a filtering chamber is formed inside the filtering cloth. The apparatus further includes a means for sucking said filtering cloth through the filtering chamber, a means for expanding said filtering cloth through the filtering chamber, and a means for constantly applying a tension force to each of the filtering plate which is disposed to be over the periphery of each of the plurality of the filtering plates. A filtering frame for surrounding each of the filtering plates is provided on its outer periphery. The means for constantly applying a tension force provided between the lower side of the filtering frame and the lower side of the corresponding filtering plate consists of a vertically extending elastic member. A slide mechanism for moving said filtering plate in the lateral direction is provided between the upper side of the filtering frame and the upper side of the corresponding filtering plate. The sliding mechanism includes a means for limiting the vertical movement of the filtering plate.

### TECHNICAL FIELD

The present invention relates to a filtering and condensing apparatus of a suction type, and, in particular, relates to such an apparatus which is capable of preventing a slack of a lower portion of a filtering cloth, while at the same time of maintaining an integrity of such a filtering cloth.

### BACKGROUND OF THE INVENTION

Conventionally, a filtering and condensing apparatus of a suction type has been adopted in order to condense agglomerated sludge generated at a water purification plan, for instance. One example of such an apparatus is disclosed by Japanese Patent Publication HEI03-23203.

This filtering and condensing apparatus comprises a sludge tank for containing sludge which is to be filtered and condensed, and a plurality of filtering plates disposed to be adjacent to each other so as to be aligned with each other in the sludge tank, each of which extends in a vertical direction of the sludge tank. Each of the filtering plates includes a supporting plate and a filtering cloth in a bag form which is integrally sewed on the supporting plate and houses the supporting plate to form a filtering chamber therein. A fixing frame is provided so as to surround each of the filtering plates. A filtrate discharging tube is communicated with the filtering chamber in order for the filtrate to be discharged through the filtering chamber. In addition, a suction portion for sucking the filtering cloth through the filtering chamber and an expansion portion for expanding the filtering cloth through the filtering chamber are provided, and coil springs for constantly exerting a tension force on each of the plurality of the filtering plates is disposed to be between each of the filtering plates and the corresponding fixing plate over the periphery of each of the filtering plate.

According to the above structure of the filtering and condensing apparatus, in case of filtering, a sludge in the sludge tank is sucked and thus filtered by the filtering clothes, so that the condensed sludge is deposited on the outer surfaces of the filtering clothes, while the filtrate which has passed through the filtering clothes and thus guided into the filtering chambers can be recovered outside of the sludge tank through the filtrate discharging tube.

On the other hand, in a case where the condensed sludge is recovered, the filtering clothes are expanded by supplying a compressed air to inner surfaces of the filtering clothes through the filtering chambers, whereby the condensed sludge deposited on the outer surfaces of the filtering clothes is separated, so that the condensed sludge deposited on the bottom of the sludge tank is discharged, and as a result, it can be incinerated or reclaimed as a cake by mechanically hydrating the discharged condensed sludge. It is possible to alleviate the load of the energy needed for the mechanical hydrating treatment such as pressurizing or depressurizing, etc. by said filtering and condensing of sludge.

In a case where the sludge is filtered or where the filtering cloth is expanded, since a tension force is constantly applied to each of the filtering plates by the coil springs provided on the periphery thereof, each of the filtering plates is maintained to be stable, even if each of the filtering plates flutters or swings to contact the adjacent filtering plate due to the suction force upon the filtering, or the air fed into the filtering chamber upon the expansion of the filtering cloth, whereby technical problems in which the filtering area is substantially reduced, or the condensed sludge deposited on the outer surface of the filtering cloth is separated can be prevented.

However, the following technical problems are caused in relation to a case where such a conventional filtering and condensing apparatus of suction type is made large-sized.

That is to say, the structural integrity of the filtering cloth can be deteriorated when the slack of the lower portion of the filtering is prevented.

More specifically, in the above filtering and condensing apparatus of the suction type, a tension force in the vertical direction is constantly applied to the filtering plate to prevent the slack of the filtering cloth by the coil springs provided on the upper and lower portions of each of the filtering plate.

However, the upper coil springs are caused to be extended due to the weight of the condensed sludge deposited on the surface of the corresponding filtering cloth, On the other hand, the lower coil springs are caused to be contracted. This causes the tension force of the lower coil springs to be reduced, so that the lower portion of the filtering cloth can be slackened, whereby the filtering plates adjacent to each other can contact to substantially reduce the filtering area, or to block the formation of the condensed sludge.

In order to prevent such a technical problem, the filtering plate can be fixed by using a connecting member at the upper portion of the filtering plate, in stead of the upper coil springs. More specifically, unlike the coil spring, the upper end of the connecting member which substantially neither extends nor contracts in the vertical direction is fixed to the upper side of the fixing plate, while the lower end thereof is fixed to the upper side of the corresponding filtering plate. Since this can limit the shifting of the connecting member itself in the vertical direction, the lower portion of the filtering cloth can be prevented from being slackened due to the weight of the condensed sludge deposited on the filtering cloth.

However, in a case where the filtering cloth is expanded in order to separate the condensed sludge from the filtering cloth, the supporting plate is caused to be contracted in the horizontal direction upon the expansion of the filtering cloth due to the fact that the filtering cloth is integrally sewed on the supporting plate, and thus, each of the supporting plates is caused to move in the horizontal direction. On the other hand, in a case where the filtering cloth is caused to be swollen due to the fact that the filtering cloth is immersed into the sludge for a long time, the supporting plate is caused to be extended in the horizontal direction upon the swelling of the filtering cloth, and thus, each of the supporting plates is caused to move in the horizontal direction.

A stress is caused to be concentrated on the point where the filtering cloth is fixed by the connection member due to the horizontal movement of each of the filtering plates, so that the filtering cloth can be broken or torn.

In order to prevent such a break of the filtering cloth, a shackle which is a suspending metal fixture can be adopted instead of the connecting member. More specifically, the upper end of the shackle is suspended from the upper side of the fixing frame so as to be swingable in the horizontal direction, while the lower end of the shackle is fixed to the upper side of the corresponding filtering plate. This causes the shackle to be swung about its upper end in a case where the filtering plate is moved in the horizontal direction upon the expansion or the swelling of the filtering cloth, so that no stress can be concentrated on the fixing position of the filtering cloth, whereby the destruction of the filtering cloth can be prevented.

However, it is difficult for such a shackle to meet requirements caused by making the filtering and condensing apparatus of the suction type large-sized. More specifically, when the filtering area of the supporting plate is increased by making the filtering and condensing apparatus of the suction type large-sized, the amount of the horizontal movement of the filtering plate upon the expansion or the immersion of the filtering cloth is inevitably increased. On the other hand, since an absorption of the horizontal movement of the filtering plate by the shackle is determined by the length and the swing angle of the shackle, there inevitably exists a limit for such an absorption. When the absorption exceeds such a limitation, similar to the case of the above connecting member, the stress can concentrate on the fixing position of the filtering cloth. In this case, the shackle may be lengthened, however, this causes the filtering area to be reduced in a limited inner space of the sludge tank, whereby the filtering efficiency can be lowered.

In view of the above technical problems, the object of the present invention is, in a case where a filtering and condensing apparatus of a suction type is made large-sized, to provide such an apparatus which is capable of securing an integrity of a filtering cloth, while at the same time of preventing a lower portion of the filtering cloth from being slackened by maintaining the vertical tension force applied to the filtering cloth to be substantially constant.

### SUMMARY OF THE INVENTION

In view of the above technical problems, according to an aspect of the invention, there is provided a filtering and condensing apparatus of a suction type comprises a sludge tank for containing sludge to be filtered and condensed, and a plurality of filtering plates aligned with each other so as to be disposed to be adjacent to each other in the sludge tank, each plane portion of which extends in the vertical direction, each of the filtering plates includes a supporting plate in the form of a net, and a filtering cloth in a bag form so as to be integrally sewed on the supporting plate and to house said supporting plate, whereby a filtering chamber is formed inside the filtering cloth, and said apparatus further includes a means for sucking said filtering cloth through said filtering chamber, a means for expanding said filtering cloth through said filtering chamber, and a means for constantly applying a tension force to each of the filtering plates which is disposed to be over the periphery of each of the filtering plates, characterized in that a filtering frame for surrounding each of said filtering plates is provided on its outer periphery, said means for constantly applying a tension force provided between the lower side of the filtering frame and the lower side of said corresponding filtering plate consists of a vertically extending elastic member, a slide mechanism for moving said filtering plate in the lateral direction is provided between the upper side of the filtering frame and the upper side of the corresponding filtering plate, said sliding mechanism includes a means for limiting the vertical movement of the filtering plate.

According to the above filtering and condensing apparatus of the suction type, by sucking and thus filtering sludge contained in the sludge tank through the filtering clothes, water contained in the sludge passes through the filtering clothes and thus guided into the filtering chambers, while the sludge which has been hydrated is caused to be deposited on the outer surfaces of the filtering clothes to be filtered and condensed. In such a case, since a tension force is constantly applied to the periphery of each of the filtering plates, each of the filtering plates can be maintained to be stable, and as a result, in case of the suction, for instance, the deposited and condensed sludge can be prevented from being naturally separated from the filtering clothes due to the fact that the filtering plate can flutter, or the formation of the condensed sludge can be prevented from being blocked, or the effective filtering area can be prevented from being decreased due to the fact that the adjacent filtering plates contact.

In a case where each of the filtering clothes is expanded in order to separate the condensed sludge from the corresponding filtering cloth, the corresponding supporting plate is caused to laterally contract so that the corresponding filtering plate is caused to be laterally moved as the filtering cloth expands, due to the fact that the filtering cloth is integrally sewed on the corresponding supporting plate. However, since the sliding mechanism for making the filtering plate laterally slidably movable is provided between the upper side of the corresponding filtering frame and the upper side of the filtering plate, a stress can be prevented from being concentrated on the fixing position of the filtering cloth to break or tear the filtering cloth due to the fact that the lateral movement of said filtering plate is limited.

On the other hand, in a case where each of the filtering clothes is swollen due to the fact that the filtering cloth is immersed into the sludge for a long time, the corresponding supporting plate is caused to be laterally extended so that the corresponding filtering plate is caused to be laterally moved as the filtering cloth becomes swollen due to the fact that the filtering cloth is integrally sewed on the corresponding supporting plate. However, since the sliding mechanism for making the filtering plate laterally slidably movable is provided between the upper side of the corresponding filtering frame and the upper side of the corresponding filtering plate, a stress can be prevented from being concentrated on the fixing position of the filtering cloth to break or tear the filtering cloth due to the fact that the lateral movement of the filtering plate is limited.

The amount of the lateral movement of the filtering plate due to such an expansion or the swelling of the filtering cloth becomes inevitably larger as the size of the filtering and condensing apparatus of the suction type becomes large.

In addition, due to the fact that the condensed sludge is deposited on each of the filtering clothes, an elastic member which is provided between the lower side of the corresponding filtering frame and the lower side of the corresponding filtering plate and vertically extends tends to be contracted due to the weight of the deposited condensed sludge, so that the tension force downwardly applied to the filtering cloth tends to be decreased. However, since the vertical movement of the filtering plate is limited by the means for limiting the vertical movement provided on the sliding mechanism, the filtering cloth can be prevented from being slackened due to the contraction of the elastic member provided on the lower portion of the filtering plate, so that it can be prevented from contacting the adjacent filtering plate. The amount of the contract of the elastic member due to the deposit of the condensed sludge on the filtering cloth is inevitably increased as the filtering and condensing apparatus of the suction type becomes big, since the bigger the filtering and condensing apparatus of the suction type becomes, the more the amount of the deposit of the condensed sludge becomes.

As described above, according to the filtering and condensing apparatus of the suction type of the present invention, in a case where the filtering and condensing apparatus of the suction type is to be made bigger sized, the lower portion of the filtering cloth can be prevented from being slackened by keeping an integrity of the filtering cloth, while at the same time maintaining the vertical tension force applied to the filtering cloth to be substantially constant.

According to a preferred configuration, said sliding mechanism includes a guiding member which is provided on the upper side of said filtering frame and extends in the lateral direction relative to the filtering frame and a guided member provided on the upper side of the corresponding filtering plate and laterally slidably engages said guiding member, said means for limiting the vertical movement is formed by said guided member engaging said guiding member.

According to a preferred configuration, said guiding member comprises a rail, said guided member includes a vertically extending engaging portion a lower end of which is fixed to said filtering plate and an upper end of which engages said rail.

According to a preferred configuration, said guided member comprises a plurality of guide members laterally spaced apart from each other with a predetermined distance.

According to a preferred configuration, said engaging portion comprises a ring into which said rail can be penetrated.

According to a preferred configuration, said engaging portion comprises a hook with a C-shaped cross section which can hook said rail.

According to a preferred configuration, said sliding mechanism includes a guiding member which is fixed to the upper side of said filtering frame and downwardly extends from the filtering frame, and a guided member which is provided on the upper side of the corresponding filtering plate and laterally slidably engages said guiding member.

According to a preferred configuration, said guided member comprises laterally prolonged eyelets provided on said filtering cloth, and an engaging portion engaging said eyelets is provided on the lower end of said guiding member.

According to a preferred configuration, said engaging portion comprises a ring which can engage said eyelets.

According to a preferred configuration, said engaging portion comprises a hook with a C-shaped cross section which can hook said eyelets.

According to a preferred configuration, said apparatus further includes a sliding mechanism for laterally slidably moving said filtering plate is provided between the lower side of the filtering frame and the lower side of the corresponding filtering plate, said sliding mechanism includes a guiding member which is provided on the lower side of the filtering frame and laterally extends relative to the filtering frame, and a guided member which is provided on the lower side of the corresponding filtering plate and laterally slidably engages said guiding member, said guided member consists of said elastic member.

According to a preferred configuration, said guiding member comprises a rail, said guided member vertically extends and its upper end is fixed to said filtering plate, and includes at its lower end an engaging portion engaging said rail.

According to a preferred configuration, said engaging portion comprises a ring into which said rail can penetrate.

According to a preferred configuration, said engaging portion comprises a hook with a C-shaped cross section which can hook said rail.

According to a preferred configuration, said elastic member comprises a coil spring made of SUS.

According to a preferred configuration, a weight member is further mounted on the lower portion of said filtering cloth, whereby a tension force is downwardly applied to said filtering cloth due to its weight.

In view of the above technical problems, according to an aspect of the invention, there is provided a filtering and condensing apparatus of a suction type comprising a filtering and condensing tank for containing a liquid including material to be filtered and condensed, and a plurality of filtering plates aligned with each other so as to be disposed to be adjacent to each other in the filtering and condensing tank, each plane portion of which extends in the vertical direction, each of the filtering plates includes a supporting plate in the form of a net, and a filtering cloth in a bag form so as to be integrally sewed on the supporting plate and to house said supporting plate, whereby a filtering chamber is formed inside the filtering cloth, and said apparatus further includes a means for sucking said filtering cloth through said filtering chamber, a means for expanding said filtering cloth through said filtering chamber, and a means for constantly applying a tension force to each of the filtering plates which is disposed to be over the periphery of each of the filtering plates, characterized in that a filtering frame for surrounding each of said filtering plates is provided on its outer periphery, said means for constantly applying a tension force provided between the lower side of the filtering frame and the lower side of said corresponding filtering plate consists of a vertically extending elastic member, a slide mechanism for moving said filtering plate in the lateral direction is provided between the upper side of the filtering frame and the upper side of the corresponding filtering plate, said sliding mechanism includes a means for limiting the vertical movement of the filtering plate.

### EFFECT OF THE INVENTION

According to the filtering and condensing apparatus of a suction type of the present invention, in a case where each of the filtering clothes is expanded in order to separate the condensed sludge from the corresponding filtering cloth, or in a case where each of the filtering clothes is swollen due to the fact that the filtering cloth is immersed into the sludge for a long time, the corresponding supporting plate is caused to laterally contract so that the corresponding filtering plate is caused to be laterally moved as the filtering cloth expands, due to the fact that the filtering cloth is integrally sewed on the corresponding supporting plate, however, since the sliding mechanism for making the filtering plate laterally slidably movable is provided between the upper side of the corresponding filtering frame and the upper side of the filtering plate, a stress can be prevented from being concentrated on the fixing position of the filtering cloth to break or tear the filtering cloth due to the fact that the lateral movement of said filtering plate is limited, while on the other hand, an elastic member which is provided between the lower side of the corresponding filtering frame and the lower side of the corresponding filtering plate and vertically extends tends to be contracted due to the weight of the deposited condensed sludge, so that the tension force downwardly applied to the filtering cloth tends to be decreased, however, since the vertical movement of the filtering plate is limited by the means for limiting the vertical movement provided on the sliding mechanism, the filtering cloth can be prevented from being slackened due to the contraction of the elastic member provided on the lower portion of the filtering plate, so that it can be prevented from contacting the adjacent filtering plate, and as a result, in a case where the filtering and condensing apparatus of the suction type is to be made bigger sized, the lower portion of the filtering cloth can be prevented from being slackened by keeping an integrity of the filtering cloth, while at the same time maintaining the vertical tension force applied to the filtering cloth to be substantially constant.

### DETAILED DESCRIPTION OF EMBODIMENTS OF THE INVENTION

The first embodiment in which sludge generated at a sewage disposal plant or a water purification plant is to be filtered and condensed will be described in detail with reference to the drawings.

As shown in FIG. 1, a filtering and condensing apparatus 10 generally comprises a sludge tank 12 for containing sludge which is to be filtered and condensed, a plurality of filtering plates 14 disposed to be within the sludge tank 12, a suction portion 16 for sucking the sludge, and an expanding portion 20 for expanding a filtering cloth 18 provided on each of the filtering plates 14.

The sludge tank 12 is a container including a bottom with a rectangular cross section and includes a volume so as to house the plurality of the filtering plates 14 which are described below. One end of a sludge supply/discharge tube 24, which supplies the sludge to the sludge tank 12, is communicated with a sidewall 22 of the sludge tank 12, and a sludge supply/discharge pump 28 which can be reversibly operated is provided via a sludge supply/discharge valve 26 provided on an intermediate part of the sludge supply/discharge tube 24. This causes the sludge to be supplied to the sludge tank 12 by opening the sludge supply/discharge valve 26 and operating a sludge supply/discharge pump 28, while causes the non-condensed sludge to be discharged from the sludge tank 12 by reversibly operating the sludge supply/discharge pump 28. In addition, one end of a condensed sludge discharge tube 30, which discharges the condensed sludge deposited on the bottom of the sludge tank 12, is communicated with the bottom portion of the sludge tank 12 and a condensed sludge discharge valve 32 is provided on an intermediate part of the condensed sludge discharge tube 30. The condensed sludge deposited on the bottom of the sludge tank 12 is discharged outside due to the force of gravity via the condensed sludge discharge tube 30 by opening the condensed sludge discharge valve 32.

As shown in FIG. 2, the plurality of the filtering plates 14 (14A to 14 E) are aligned with each other in the sludge tank 12 in such a way that their plane portions 13 extend in the vertical direction and the adjacent filtering plates 14 are spaced apart from each other with a predetermined distance D. The smaller the distance D between the adjacent filtering plates 14 becomes, the higher the number of the filtering plates 14 which can be housed within the sludge tank 12 becomes, whereby the total filtering area can be increased accordingly. However, as described below, it is necessary to expand the filtering cloth 18 in order to separate the condensed sludge deposited on the filtering cloth 18 from the corresponding filtering plate 14. Since the filtering cloth 18 protrudes toward the adjacent filtering plate 14 due to the expansion of the filtering cloth 18, there is a risk that the filtering cloth 18 can contact the adjacent filtering plate 14, so that the filtering area cannot be effectively utilized. Such being the case, the distance between the adjacent filtering plates 14 may be determined, in view of the condition that the adjacent filtering plates 14 remain in non-contact, while the total filtering area is maximized.

Each of the plurality of the filtering plates 14 is connected at its upper portion to a filtrate reservoir 36 disposed to be outside of the sludge tank 12 via a distribution tube 34. One end of a filtrate discharge tube 38 is connected to the filtrate reservoir 36 and a filtrate discharge valve 40 is provided on an intermediate part of the filtrate discharge tube 38 extending downwardly.

Each of the distribution tubes 34 and the filtrate discharge tube 38 are connected in a U-shaped manner via the filtrate reservoir 36, so that the filtrate which has been filtered within the sludge tank 12 is discharged outside based on siphon-age. In addition, a suction tube 31 is branched from each of the distribution tubes 34 and a vacuum pump 35 is connected to the suction tube 31 via a suction valve 33 provided on an intermediate part thereof. This causes the liquid within the sludge tank 12 to be treated to be sucked to the distribution tubes 34 by operating the vacuum pumps 35 while the suction valves are open, whereby a preparation for discharging the filtrate outside via the filtrate discharge tube 38 based on the siphon-age can be carried out.

On the other hand, one end of an air supply tube 42 is connected to the filtrate reservoir 36 and a compressor 46 is connected to the air supply tube 42 via an air supply valve 44 provided on an intermediated part thereof. This causes compressed air to be supplied to a filtering chamber 76 of each of the filtering plates 14 via the air supply tube 42, the filtrate reservoir 36 and the corresponding distribution tube 34 by operating the compressor 46 while the air supply valve 44 is open, whereby the corresponding filtering cloth 18 can be expanded in a case where the condensed sludge which is described below is separated from said filtering cloth 18. In this connection, one end of each of the distribution tubes 34 is connected to a horizontal tube 15 provided on the upper portion of the corresponding filtering plate 14, and an outlet opening (not shown) is provided on the lower portion of the horizontal tube 15 at every zone of the corresponding filtering cloth 18 which is divided by seams 74 adjacent to each other which is described below. This causes the compressed air to be fed to every zone of the filtering cloth 18 by the compressor 46 via the corresponding outlet opening or causes the siphoning type suction to be effected by the vacuum pump 35.

Since the structures of the plurality of the filtering plates 14 are the same, the structure of one of the filtering plates will be described below.

As show in FIG. 3, the filtering plate 14 generally comprises a filtering frame 48, a supporting plate 50 disposed to be inside of the filtering frame 48, the filtering cloth 18 in a bag form inside of which the supporting plate 50 is housed, a plurality of coil springs 54 provided between the filtering frame 48 and the supporting plate 50. The filtering frame 48 is shaped to be hollow and rectangular and includes an upper side 56, a lower side 58 and lateral sides 60, 62 between the upper side 56 and the lower side 58. The filtering plate 14 is suspended and supported from an inner side surface 68 of the sludge tank 12 by both end portions of the upper side 56. More specifically, as shown in FIG. 4, an extension 64 is provided on each of both end portions of the upper side 56, while a pair of guide plates 70, 72, each of which protrudes towards inside, are provided on the inner side surface 68 of the sludge tank 12, so that an engaging plate 66 fixed on the upper surface of the extension 64 is adapted to rest on the upper surface of the pair of the guide plates 70, 72 by disposing the end portion of the extension 64 to be between the pair of guide plates 70, 72. This causes each of the filtering plates 14 to be suspended from the sludge tank 12. The distance between the adjacent filtering plates 14 is determined by selecting the pair of guide plates 70, 72 from which the filtering plates 14 are suspended. Such a distance may be varied by selecting the pair of guide plates 70, 72 in accordance with the amount of condensed sludge deposited on the filtering cloth 18, the value of the negative pressure caused by the suction, and the lateral length of the zone of the filtering cloth 18 which is described below, for instance.

The supporting plate 50 is in the form of a net or a mesh and is rectangular-shaped. Innumerable fine holes are provided on the supporting plate 50. A plurality of flow paths of the filtrate, each of which extends in the vertical direction of the supporting plate 50 are formed between the concave portion of the supporting plate 50 and the inner surface of the corresponding filtering cloth 18 by the fact that concave and convex portions (not shown) vertically extending are provided on the surface of the supporting plate 50. The supporting plate 50 is made of resin, and in particular, it is preferable that the supporting plate 50 has characteristics such that it neither extends in a plane of the supporting plate 50, nor is deformed to deteriorate a flatness of the supporting plate 50 due to the fact that the filtering cloth 18 is immersed into the sludge, and furthermore, it neither contracts in a plane of the supporting plate 50 nor is deformed to deteriorate the flatness of the supporting plate 50 due to the fact that the filtering cloth 18 is expanded. More specifically, the supporting plate 50 is preferably made of polyethylene or EVA. In a case where the filtering cloth 18 is immersed into the sludge for a long time, or the filtering cloth is expanded, a tension force applied to the filtering plate 14 by the coil spring 54 which is described below can be maintained to be substantially constant by adopting such material.

The filtering cloth 18 is preferably made of chemical fiber, more preferably, nylon. The filtering cloth 18 may be formed into a bag form by overlapping a pair of rectangular cloth to sew the overlapped peripheral edge portions, or bending a single rectangular cloth so as to overlap the opposed edge portions to sew the peripheral edge portions. A plurality of eyelets 78 are provided on the periphery of the filtering cloth 18 so that one end of the coil spring 54 which is described below can be hooked by the corresponding eyelet 78.

A plurality of seams 74, each of which vertically extends, are provided on the filtering cloth 18, and the filtering cloth 18 is integrally sewed on the supporting plate 50 which is housed in the filtering cloth 18. This causes the filtering cloth 18 to be divided along the lateral direction (the direction perpendicular to the vertical direction of the sludge tank 12), thereby causing the filtering chamber 76 to be formed between the inner surface of the filtering cloth 18 and the supporting plate 50 at each divided zone (refer to FIG. 5). The distances between the adjacent seams 74 do not have to be the same, however, it is preferable that such a distance be determined in view of the fact that the total filtering area of the whole filtering plates 14 is maximized by disposing the filtering plates 14 to be as close as possible, while causing no risk of contact of the adjacent filtering plates 14.

More specifically, as shown in FIG. 5(A), in order to separate the condensed sludge from the filtering cloth 18, by feeding a compressed air into the corresponding filtering chamber 76 by the compressor 46, in a case where the filtering cloth 18 is expanded, the filtering cloth 18 is caused to protrude toward the adjacent filtering plate. However, such a protrusion P can be decreased by dividing the filtering cloth 18 in the lateral direction and expanding each divided zone, whereby the distance D can be shortened.

In addition, the lateral length of the filtering cloth 18 is set to be longer than that of the corresponding supporting plate 50 at every zone which is divided by the adjacent seams 74 of the filtering cloth 18 over the entire vertical length of the filtering cloth 18. This causes an expanding margin to be provided at every zone in a case where the filtering cloth 18 is expanded. As shown in FIG. 5 (B), in case of filtering, most of the filtering cloth 18 is adhered to the surface of the corresponding supporting plate 50 by the fact that the filtering cloth 18 is sucked by the filtering chamber 76, a wrinkled portion 71 which is not adhered to the supporting plate 50 is formed along the vertical direction of the supporting plate 50. On the other hand, in a case where the filtering cloth 18 is expanded, the forfeit of the normal filtering function of the filtering cloth 18 or the break or the tearing of the filtering cloth 18 due to the fact that the fine holes of the filtering cloth 18 are enlarged can be prevented in advance without the filtering cloth 18 being excessively tensioned.

As shown in FIG. 3, a plurality of coil springs 54 are provided between the lateral side 60 of the filtering frame 48 and the lateral side 61 of the corresponding filtering cloth 18, the lateral side 62 of the filtering frame 48 and the lateral side 63 of the filtering cloth 18, and the lower side 58 of the filtering frame 48 and the lower side 59 of the filtering cloth 18. A distance between the adjacent coil springs 54 provided on both side portions and the lower side of the filtering frame 48 may be appropriately determined in accordance with the size of the filtering cloth 18, the amount of the condensed sludge deposited on the filtering cloth 18, etc. More specifically, one end portion of each of the coil springs 54 is hooked by the eyelets 78 of the filtering cloth 18, while the other end thereof is fixed to the lateral sides 60, 62 or the lower side 58 of the filtering frame 48. The plurality of coil springs 54 may be preferably made of SUS, from the resistance to corrosion point of view, and the coil springs 54 may be preferably standard products, not made-to-order products since tens of coil springs are disposed to be around the filtering plate 14 and tens of the filtering plates 14 are provided.

On the other hand, as shown in FIGS. 3 to 6, in each of the filtering plates 14, a sliding mechanism 100 which makes the corresponding filtering plate 14 laterally movable is provided between the upper side 56 of the corresponding filtering frame 48 and the upper side 57 of the corresponding filtering cloth 18, and the sliding mechanism 100 includes a means for limiting a vertical movement of the filtering plate 14. The sliding mechanism 100 includes a guiding member 104 which is provided on the upper side 56 of the filtering frame 48 and laterally extends relative to the filtering frame 48 and guided members 106, each of which is provided on the upper side 57 of the filtering plate 14 and engages the guide member 104 so as to be laterally be slid on the guide member 104, and the means for limiting the vertical movement of the filtering plate 14 is formed by the fact that each of the guided members 106 engages the guiding member 104. The guiding member 104 consists of a single rail. The length of the rail is set to be a little longer than that of the lateral length of the corresponding filtering cloth 18. The shape of the cross section of the rail can be any, such as a polygon, a circle, etc., so long as the filtering plate 14 can be laterally movable via the guided members 106.

Each of the guided members 106 vertically extends and its lower end 108 is fixed to the corresponding filtering cloth 18, and includes at its upper end 110 an engaging portion 112 engaging the rail. Each of the guided members 106, unlike the coil spring, is made of a material which causes substantially no vertical extension, a metal, for instance, and a plurality of guided members 106 are provided so as to be spaced apart from each other with a predetermined distance in the lateral direction of each of the filtering plates 14. The predetermined distance between the adjacent guided members 106 may be appropriately determined in accordance with the size of the filtering plate 14, the amount of the condensed sludge deposited on the filtering cloth 18, etc. In such a case, each of the guided members 106 may be provided at every zone of the filtering cloth 18. The vertical length of each of the guided members 106 may be preferably as short as possible, from the technical point of view that the filtering area of the filtering plates 14 is maximized. The engaging portion 112 consists of a ring into which the rail can be penetrated, and the size of the ring may be preferably as small as possible, so long as the rail can be penetrated into the ring. As an alternative, the engaging portion 112 may be a hook with a C-shaped cross section by which the rail can be hooked. As compared to the ring, in case of the hook, the hook can be easily removed from the rail via an opening portion of the hook due to its movement toward to the adjacent filtering plate 14, On the other hand, there is a technical advantage that the filtering plate 14 can be readily mounted on the rail, or be detached from the rail.

Now, the operation of the filtering and condensing apparatus of the suction type 10 including the above structure will be described.

Firstly, the sludge is fed to the sludge tank 12. More specifically, the sludge supply/discharge valve 26 is opened while the sludge discharge valve 32 is closed, and then the sludge supply/discharge pump 28 is actuated, so that the sludge which is to be filtered and condensed is fed into the sludge tank 12 up to a level which corresponds to a top portion of the filtering plate 14 via the sludge supply/discharge tube 24.

Then, the preparation for filtering and condensing the sludge in the sludge tank 12 in a siphoned manner is carried out. More specifically, the suction valve 33 is opened and the vacuum pump 35 is actuated, so that the liquid in the filtering clothes 18 is sucked into the filtrate reservoir 36 via the distribution tubes 34. The filtrate guided into the filtering chambers 76 can be discharged outside via the sludge discharge tube 38 by the siphon-age in accordance with the difference between the level of the end portion at the side of the filtering plate 14 of each of the distribution tubes 34 and the level of the filtrate reservoir 36.

Then, the sludge in the sludge tank 12 is filtered and condensed. More specifically, the sludge in the sludge tank 12 is sucked toward the outer surface of each of the filtering clothes 18 by the siphon-age. At this stage, water contained in the sludge passes through the filtering clothes 18 and is guided into the filtering chambers 76 as filtrate, while the sludge is dehydrated, so that the condensed sludge is deposited on the outer surfaces of the filtering clothes 18. Since the margin for expanding the filtering cloth is provided at every zone of each of the filtering clothes 18, most of the filtering cloth 18 in every zone is caused to be adhered to the corresponding supporting plate 50 due to the fact that the filtering cloth 18 is sucked, while the portion 71 which is not adhered to the supporting plate 50 is formed into a wrinkle extending in the vertical direction of the filtering cloth 18. Since this wrinkled portion 71 is formed at every divided zone at every time the sludge is filtered, there is a small tendency that this can badly influence on an integrity of the filtering cloth 18, however, a kind of tendency is formed on the filtering cloth 18 by using the filtering cloth 18 for a long time, so that the wrinkled portion 71 can be formed on the same position every time the sludge is filtered. In such a case, it is possible to prevent such a bad influence on the filtering cloth 18 due to the formation of the wrinkled portion 71 by regulating the negative pressure generated in the filtering chamber 76, for instance.

Since a tension force is constantly applied to each of the filtering plates 14 from its periphery, each of the filtering plates 14 is maintained to be stable. This causes the condensed sludge deposited on the outer surfaces of the filtering clothes 18 to be prevented from being separated from the outer surfaces of the filtering clothes 18 due to the fluttering or the shaking of the filtering plates 14.

In a case where the condensed sludge is deposited on the outer surfaces of the filtering clothes 18, the coil springs 54 which are provided between the lower side 58 of the filtering frame 48 and the lower side 59 of the corresponding filtering plate 14 and vertically extend is caused to be contracted due to the weight of the deposited condensed sludge, whereby the tension force downwardly applied to the filtering clothes 18 is decreased. However, the vertical movement of the filtering plate 14 can be limited by the guided member 106 of the slide mechanism 100. In other words, the downward movement of the filtering plate 14 can be limited due to the fact that the upper end of the ring into which the rail is penetrated engages the upper surface of the rail. This causes the filtering cloth 18 to be prevented from being slackened due to the contraction of the coil springs 54 provided on the lower portion of the filtering plate 14, whereby the contact of the filtering cloth 18 with the adjacent filtering plate 14 can be prevented.

Then, non-condensed sludge in the sludge tank 12 is discharged outside from the sludge tank 12. More specifically, the sludge supply/discharge valve 26 is opened and the sludge supply/discharge pump 28 is reversely actuated with respect to the case where the sludge is fed, so that the non-condensed sludge in the sludge tank 12 can be discharged outside via the sludge supply/discharge tube 24.

Then, the condensed sludge deposited on the filtering clothes 18 can be separated from the filtering clothes 18 by expanding the filtering clothes 18. More specifically, the air supply valve 44 is opened and the compressed air is fed into the filtering chamber 76 of each of the filtering plates 14 from the compressor 46 through the air supply tube 42, the filtrate reservoir 36, the corresponding distribution tube 34 and the corresponding horizontal tube 15. This causes each of the filtering clothes 18 whose innumerable fine holes are closed by the condensed sludge to be expanded in the direction in which each of the filtering clothes 18 is away from the corresponding supporting plate 50. In such a case, since each of the filtering clothes 18 is integrally sewed on the corresponding supporting plate 50, the supporting plate 50 is caused to be laterally contracted due to the expansion of the filtering cloth 18, thereby causing each of the filtering plates 14 to be laterally moved. However, since the sliding mechanism 100 which causes the filtering plate 14 to laterally move is provided between the upper side 56 of the filtering frame 48 and the upper side 57 of the corresponding filtering plate 14, in a case the filtering plate 14 is laterally moved, each of the guided members 106 whose lower end 108 is fixed to the corresponding filtering plate 14 is forced to be laterally moved together with the filtering plate 14 (the lateral direction in FIG. 6), the ring provided on each of the upper ends 110 of the guided members 106 is caused to be slid on the rail so as to be guided by the rail which serves as the guiding member 104, whereby the filtering plate 14 can be freely laterally moved. This prevents the filtering cloth 18 from being broken due to the fact that the concentration of the stress on the fixing position of the filtering cloth 18 caused by the restriction of the lateral movement of the filtering plate 14.

In addition, since the expanding margin is provided on every divided zone of the filtering cloth 18, the filtering cloth 18 can be prevented from being excessively tensioned in such a way that the fine holes are forced to be enlarged, or that the filtering cloth 18 is caused to be broken. Further, the supporting plate 50 integrally sewed on the corresponding filtering cloth 18 is subjected to the compressive force due to the expansion of the filtering cloth 18, so that it is forced to be laterally contracted. However, the lateral length of the supporting plate 50 can be maintained to be substantially constant due to the rigid supporting plate 50, whereby the tension force by the coil springs 54 transmitted from the side of the supporting plate 50 can be maintained to be substantially constant.

Then, the separated condensed sludge is discharged outside from the sludge tank 12. More specifically, the sludge discharge valve 32 is opened, and then the condensed sludge deposited on the bottom of the sludge tank 12 is discharged outside of the sludge tank 12 via the condensed sludge discharge tube 30 due to the gravity force. The above processes complete the filtering and condensing operation of the sludge.

The filtering cloth 18 tends to swell due to the fact that it is immersed into the sludge for a long time, whereby the corresponding supporting plate 50 is forced to be laterally extended, too (the lateral direction in FIG. 6). In such a case, since the filtering cloth 18 is integrally sewed on the corresponding supporting plate 50, the supporting plate 50 tends to be laterally extended, whereby each of the filtering plate 14, too, is caused to laterally move. In a case where the filtering plate 14 laterally moves, each of the guided members 106, the lower end 108 of which is fixed on the filtering plate 14, tends to laterally move together with the filtering plate 14. However, since the sliding mechanism 100 for making the filtering plate 14 laterally movable is provided between the upper side 56 of the filtering frame 48 and the upper side 57 of the corresponding filtering plate 14, the rings provided on the upper end 110 of each of the guided members 106 are caused to slide on the rail so as to be guided by the rail which serves as a guiding member, whereby the filtering plate 14 can freely laterally move. Like the above case where the filtering cloth 18 is expanded, this prevents the filtering cloth 18 from being broken due to the fact that the concentration of the stress on the fixing position of the filtering cloth 18 caused by the restriction of the lateral movement of the filtering plate 14.

On the other hand, the lateral length of the supporting plate 50 can be maintained to be substantially constant due to the rigid supporting plate 50, whereby the tension force by the coil springs 54 transmitted from the side of the supporting plate 50 can be maintained to be substantially constant.

The condensed sludge which is discharged outside from the sludge tank 12 is further condensed by another hydrator to be formed into a cake, and then, incinerated or reclaimed.

According to the above filtering and condensing apparatus 10 of the suction type, by sucking and thus filtering sludge contained in the sludge tank 12 through the filtering clothes 18, water contained in the sludge passes through the filtering clothes 18 and thus guided into the filtering chambers 76, while the sludge which has been hydrated is caused to be deposited on the outer surfaces of the filtering clothes 18 to be filtered and condensed. In such a case, since a tension force is constantly applied to the periphery of each of the filtering plates 14, each of the filtering plates 14 can be maintained to be stable, and as a result, in case of the suction, for instance, the deposited and condensed sludge can be prevented from being naturally separated from the filtering clothes 18 due to the fact that the filtering plate 14 can flutter, or the formation of the condensed sludge can be prevented from being blocked, or the effective filtering area can be prevented from being decreased due to the fact that the adjacent filtering plates 14 contact.

In a case where each of the filtering clothes 18 is expanded in order to separate the condensed sludge from the corresponding filtering cloth 18, the corresponding supporting plate 50 is caused to laterally contract so that the corresponding filtering plate 14 is caused to be laterally moved as the filtering cloth 18 expands, due to the fact that the filtering cloth 18 is integrally sewed on the corresponding supporting plate 50. However, since the sliding mechanism 102 for making the filtering plate 14 laterally slidably movable is provided between the upper side of the corresponding filtering frame 48 and the upper side of the filtering plate 14, a stress can be prevented from being concentrated on the fixing position of the filtering cloth 18 to break or tear the filtering cloth 18 due to the fact that the lateral movement of said filtering plate 14 is limited.

On the other hand, in a case where each of the filtering clothes 18 is swollen due to the fact that the filtering cloth 18 is immersed into the sludge for a long time, the corresponding supporting plate 14 is caused to be laterally extended so that the corresponding filtering plate 14 is caused to be laterally moved as the filtering cloth 18 becomes swollen due to the fact that the filtering cloth 18 is integrally sewed on the corresponding supporting plate 50. However, since the sliding mechanism 102 for making the filtering plate 14 laterally slidably movable is provided between the upper side of the corresponding filtering frame 48 and the upper side of the corresponding filtering plate 14, a stress can be prevented from being concentrated on the fixing position of the filtering cloth 18 to break or tear the filtering cloth 18 due to the fact that the lateral movement of the filtering plate 14 is limited.

The amount of the lateral movement of the filtering plate 14 due to such an expansion or the swelling of the filtering cloth 18 becomes inevitably larger as the size of the filtering and condensing apparatus 10 of the suction type becomes large.

In addition, due to the fact that the condensed sludge is deposited on each of the filtering clothes 18, an elastic member which is provided between the lower side of the corresponding filtering frame 48 and the lower side of the corresponding filtering plate 14 and vertically extends tends to be contracted due to the weight of the deposited condensed sludge, so that the tension force downwardly applied to the filtering cloth 18 tends to be decreased. However, since the vertical movement of the filtering plate 14 is limited by the means for limiting the vertical movement provided on the sliding mechanism 102, the filtering cloth 18 can be prevented from being slackened due to the contraction of the elastic member provided on the lower portion of the filtering plate 14, so that it can be prevented from contacting the adjacent filtering plate 14. The amount of the contract of the elastic member due to the deposit of the condensed sludge on the filtering cloth 18 is inevitably increased as the filtering and condensing apparatus 10 of the suction type becomes big, since the bigger the filtering and condensing apparatus 10 of the suction type becomes, the more the amount of the deposit of the condensed sludge becomes.

As described above, according to the filtering and condensing apparatus 10 of the suction type of the present invention, in a case where the filtering and condensing apparatus 10 of the suction type is to be made large-sized, the lower portion of the filtering cloth 18 can be prevented from being slackened by keeping an integrity of the filtering cloth 18, while at the same time maintaining the vertical tension force applied to the filtering cloth 18 to be substantially constant.

Now, the second embodiment of the present invention will be described. In the following description, the explanation of elements the same as those in the first embodiment is omitted by attaching the same reference numbers to said elements, and the technical feature of this embodiment will be described in detail. FIG. 7 is an illustration in the filtering and condensing apparatus of the suction type in the second embodiment the same as FIG. 3 in the first embodiment.

As shown in FIG. 7(A), the technical feature of this embodiment lies in the fact that, in each of the filtering plate 14, a weight member 80 is provided on its lower portion. More specifically, the weight member 80 with a predetermined weight including a laterally elongated prism shape, is suspended from the lower portion of each of the filtering plates 14 via a plurality of suspending metal fittings 82. As shown in FIG. 7(B), each of the suspending metal fittings 82 includes a U-shaped body 86 including a pair of extensions 84 parallel to each other and a connecting rod 88 which connects tip ends of the pair of the extensions 84. The weight member 80 is suspended from the corresponding body 86 via a coil spring 90. The plurality of suspending metal fittings 82 are disposed in such a way that the corresponding filtering frame 48 is interposed between the pair of the extensions 84, and connected to the corresponding filtering cloth 18 by introducing the connecting rod 88 into the eyelet 78 of the corresponding filtering cloth 18.

According to the above structure, like the first embodiment, the filtering plate 14 can freely laterally move by means of the corresponding sliding mechanism 100, in case of the expansion or the immersion of the filtering cloth 18, whereby a stress can be prevented from being concentrated on the fixing position of the filtering cloth 18, and as a result, the filtering cloth 18 can be prevented from being broken or torn. In addition, if the coil spring is disposed to be a lower portion of the filtering plate 14, in case of filtering, the coil spring can be excessively contracted due to the weight of the condensed sludge gradually being deposited on the corresponding filtering cloth 18. However, since the filtering cloth 18 can be constantly drawn downwardly due to the weight member 80, the filtering cloth 18 can be prevented from being slackened due to the deposition of the condensed sludge on the filtering cloth 18. Further, since the filtering frame 48 is disposed to be interposed between the pair of extensions 84, the corresponding filtering plate 14 can be prevented from excessively being swung toward the adjacent filtering plate 14 due to the fact that said filtering plate 14 contacts the pair of the extensions 84.

Now, the third embodiment of the present invention will be described. In the following description, the explanation of elements the same as those in the first embodiment is omitted by attaching the same reference numbers to said elements, and the technical feature of this embodiment will be described in detail. FIG. 8 is an illustration in the filtering and condensing apparatus of the suction type in the third embodiment the same as FIG. 6 in the first embodiment.

The technical feature of this embodiment lies in the sliding mechanism 100 different from that of the first and second embodiments, as shown in FIG. 8. That is, in this embodiment, in each of the filtering plates 14, the sliding mechanism 100 includes a plurality of guiding member 202, each of which is fixed on the upper side 56 of the corresponding filtering frame 48 and downwardly extends from said filtering frame 48, and a plurality of guided members 204, each of which is provided on the upper side 57 of the corresponding filtering cloth 18 and engages the corresponding guiding member 202 so as to be laterally slidably moved with respect to the guiding member 202, whereby a means for limiting a vertical movement of the filtering plate 14 is formed by making the guided member 204 engage the corresponding guiding member 202.

Each of the guiding member 202 is made of a material different from the coil spring which causes substantially no vertical extension, metal, for instance. A plurality of guided members 202 are provided so as to be spaced apart from each other with a predetermined distance in the lateral direction of the corresponding filtering plate 14. The predetermined distance of the adjacent guiding members 202 may be appropriately determined in accordance with the size of the filtering plate 14, the amount of the condensed sludge deposited on the filtering cloth 18, etc. In such a case, each of the guiding members 202 may be provided at every divided zone of the filtering cloth 18. The vertical length of each of the guiding members 202 may preferably be as short as possible, in view of the technical point that the filtering area of the filtering plate 14 is maximized in a limited space of the sludge tank 12.

Each of the guided members 204 consists of a laterally elongated eyelet provided on the upper portion of the corresponding filtering cloth 18, and an engaging portion 208 engaging the eyelet is provided on the lower end 206 of the corresponding guiding member 202. The lateral length of each of the eyelets is set to be longer than the amount of the lateral movement of the corresponding filtering plate 14 in case of the expansion or the immersion of the filtering cloth 18. In such a case, since the direction in which the filtering plate 14 is laterally moved in case of the expansion of the filtering cloth 18 is opposite to that in which the filtering plate 14 is laterally moved in case of the immersion of the filtering cloth 18, the engaging portion 208 may be disposed to be a central portion in the lateral direction of the corresponding eyelet in such a way that the filtering plate 14 can be freely moved in both directions.

The engaging portion 208 may preferably be a ring which can engage the corresponding eyelet, or a hook with a C-shaped cross section which can hook the eyelet.

According to the above structure, in a case where the filtering cloth 18 is expanded in order to separate the condensed sludge from the filtering cloth 18, the corresponding supporting plate 50 is forced to laterally be contracted upon the expansion of the filtering cloth 19 and thus, each of the filtering plates 14 is caused to laterally move, since the filtering cloth 18 is integrally sewed on said supporting plate 50. However, since the sliding mechanism 100 which causes the filtering plate 14 to laterally move is provided between the upper side 56 of the corresponding filtering frame 48 and the upper side 57 of the filtering plate 14, the laterally elongated eyelets can laterally move while they keep engaging the corresponding engaging portions 208, whereby this prevents the filtering cloth 18 from being broken or torn due to the concentration of the stress on the fixing position of the filtering cloth 18 caused by the restriction of the lateral movement of the filtering plate 14.

On the other hand, in a case where each of the filtering clothes 18 is swollen due to the fact that the filtering cloth 18 is immersed into the sludge for a long time, the corresponding supporting plate 50 is caused to be laterally extended so that the corresponding filtering plate 14 is caused to be laterally moved as the filtering cloth 18 becomes swollen due to the fact that the filtering cloth 18 is integrally sewed on the corresponding supporting plate 50. However, similar to the case of the expansion of the filtering cloth 18, a stress can be prevented from being concentrated on the fixing position of the filtering cloth 18 to break or tear the filtering cloth 18 due to the fact that the lateral movement of the filtering plate 14 is limited.

In addition, in a case where the condensed sludge is deposited on the filtering cloth 18, the coil spring 54 which is provided between the lower side 58 of the corresponding filtering frame 48 and the lower side 59 of the corresponding filtering plate 14 and vertically extends tends to be contracted due to the weight of the condensed sludge, and thus the tension force tends to decrease. However, since the downward movement of the filtering plate 14 is restricted by the corresponding guiding members 202, the filtering cloth 18 can be prevented from being slackened due to the contraction of the corresponding coil springs 54 provided on the lower portion of the filtering plate 14, whereby the filtering cloth 18 can be prevented from contacting the adjacent filtering plate 14.

Now, the fourth embodiment of the present invention will be described. In the following description, the explanation of elements the same as those in the first embodiment is omitted by attaching the same reference numbers to said elements, and the technical feature of this embodiment will be described in detail, instead. FIG. 9 is an illustration in the filtering and condensing apparatus of the suction type in the fourth embodiment the same as FIG. 6 in the first embodiment.

The technical feature of this embodiment lies in the fact that, in each of the filtering plates 14, a sliding mechanism 100B for causing the filtering plate 14 laterally movable is provided between the lower side 58 of the corresponding filtering frame 48 and the lower side 59 of the corresponding filtering cloth 18, and sliding mechanisms 100C, D for causing the filtering plate 14 vertically movable are provided between the left lateral side 60 of the corresponding filtering frame 48 and the left lateral side 61 of the corresponding filtering cloth 18, and the right lateral side 62 of the corresponding filtering frame 48 and the right lateral side 63 of the corresponding filtering cloth 18, respectively.

More specifically, the slide mechanism 100B is almost the same as the slide mechanism 100A provided between the upper side 56 of the filtering frame 48 and the upper side 57 of the filtering plate 14 in the first embodiment, so that it includes a guiding member 104 laterally extending with respect to the filtering frame 48 and guided members 106, each of which is provided on the lower side 59 of the corresponding filtering cloth 18 and can engage the guiding member 104 so as to laterally slide on the guiding member 104. The guiding member 104 consists of a single rail. The length of the rail is set to be a little longer than that of the lateral length of the filtering cloth 18. The cross section of the rail may be formed to be any shape such as a polygon, a circle, etc., so long as the filtering plate 14 can be laterally moved via the guided members 106. Each of the guided members 106 vertically extends, and its lower end is fixed to the corresponding filtering cloth 18, and includes at its upper end an engaging portion 112 which engages the rail. The guided members 106 consist of coil springs and are spaced apart from each other in the lateral direction of the corresponding filtering plate 14 with a predetermined distance. The distance between the adjacent guided members 106 may be appropriately determined in accordance with the size of the filtering plate, the amount of the condensed sludge deposited on the filtering cloth 18, etc. In this case, the guided member 106 may be provided at every divided zone of the filtering cloth 18. The vertical length of each of the guided members 106 may be preferably as short as possible, in view of the maximizing of the filtering area of the filtering plate 14 in a limited space within the sludge tank 12. Each of the engaging portions 112 consists of a ring into which the rail can penetrate, and the size of the ring may be preferably small, so long as the rail can penetrate thereinto. As an alternative, each of the engaging portions 112 may be a hook with a C-shaped cross section which can hook the rail. As compared to the ring, in case of the hook, while there is a risk that the hook can be disengaged from the rail via the opening portion of the hook when the filtering plate 14 is moved toward the adjacent filtering plate 14, there is a technical advantage that the filtering plate 14 can be readily attached to, or detached from the rail.

With respect to the sliding mechanism 100C, a guiding member 104 vertically extending is provided on the left lateral side 60 of the corresponding filtering frame 48, while guided members 106, one end of each of which is fixed to the corresponding plate 14 and at the other end of each of which a ring into which a rail can penetrate is provided, is provided on the left lateral side 61 of the corresponding filtering cloth 18. In a case where the corresponding plate 14 is vertically moved, it is adapted to be smoothly moved while it is slidably guided by the rail serving as the guiding member 104 via the rings provided at the tip portions of the guided members 106. The guided members 106 consist of the coil springs 54, like the case of the sliding mechanism 100B.

Since the sliding mechanism 100D provided on the right lateral side of the corresponding filtering cloth 18 is the same as the sliding mechanism 100C, the explanation thereabout is omitted.

According to the above structure, in a case where the filtering plate 14 is caused to be laterally moved due to the expansion, or the swelling of the corresponding filtering cloth 18, the filtering plate 14 can be smoothly laterally moved due to the provision of the sliding mechanisms 100A, 100B provided on the upper and lower portions of the filtering plate 14, respectively. In addition, in a case where the filtering plate 14 is downwardly moved due to the weight of the condensed sludge deposited on the corresponding filtering cloth 18, the filtering plate 14 itself can be smoothly downwardly moved, while the coil springs 54 provided on both lateral sides of the filtering plate 14 can be prevented from being downwardly diagonally extended.

In this connection, as an alternative, the sliding mechanism may be provided on only one lateral side of the filtering plate 14, or may be provided on a portion of the lateral side of the filtering plate 14.

As stated above, the preferred embodiments of the present invention were described in detail, however, it is evident that those skilled in the art could modify or change the embodiments in various manners without departing from the scope of the present invention.

For instance, in the first embodiment, the sludge was described to be the object to be filtered and condensed, however, the filtering and condensing apparatus of the suction type of the present invention can be applicable to incineration ash contained in an alkali solution, foreign objects contained in the beverages such as milk, juice, foreign objects in a high turbidity solution, etc., so long as the conditions such as the kind of the filtering cloth, the size of diameter of the fine holes, the suction force, etc. are appropriately set in accordance with the object to be filtered and condensed.

In addition, in the first embodiment, in each of the filtering plates 14, the filtering cloth 18 is laterally divided by providing a plurality of seams vertically extending, and the expanding margin is provided at every divided zone, however, a single filtering chamber 76 may be provided at each of the sides of the supporting plate 50 without the filtering cloth 18 being divided.

Further, in the first embodiment, with respect to the supporting plate 50, it is described that the supporting plate 50 is made of a rigid resin material which causes substantially no deformation so as to extend it in its plane, or so as to deteriorate its flatness due to the fact that the filtering cloth 18 is immersed into the sludge and which causes no deformation so as to contract it in its plane, or so as to deteriorate its flatness due to the fact that the filtering cloth 18 is expanded, however, the filtering and condensing apparatus of the suction type of the present invention can be applicable to a soft resin material which can cause said above deformation.

Still further, in the first embodiment, the filtering and condensing apparatus of the siphon type was described, however, the filtering and condensing apparatus of the suction type utilizing a suction pump can be adopted, so long as the negative pressure is appropriately set, taking an influence on the filtering cloth 18 into consideration.

Still further, in the first embodiment, the coil springs 54 were adopted as elastic members, however, rubber plates, etc. can be adopted, so long as the desired tension force can be obtained.

### INDUSTRIAL APPLICABILITY

The filtering and condensing apparatus of the suction type of the present invention can be applicable not only to the technical field of the water treatment, but also to that of the food or chemical industry, and, in particular, it is advantageous in a case where the filtering and condensing apparatus of the suction type, which is to be applied to a condensing process of sludge generated during the water treatment at a water purification plant or a sewage disposal plant, is made large.

### BRIEF DESCRIPTION OF THE DRAWINGS

FIG. 1 is a general view showing a filtering and condensing apparatus of a suction type in the first embodiment of the present invention.

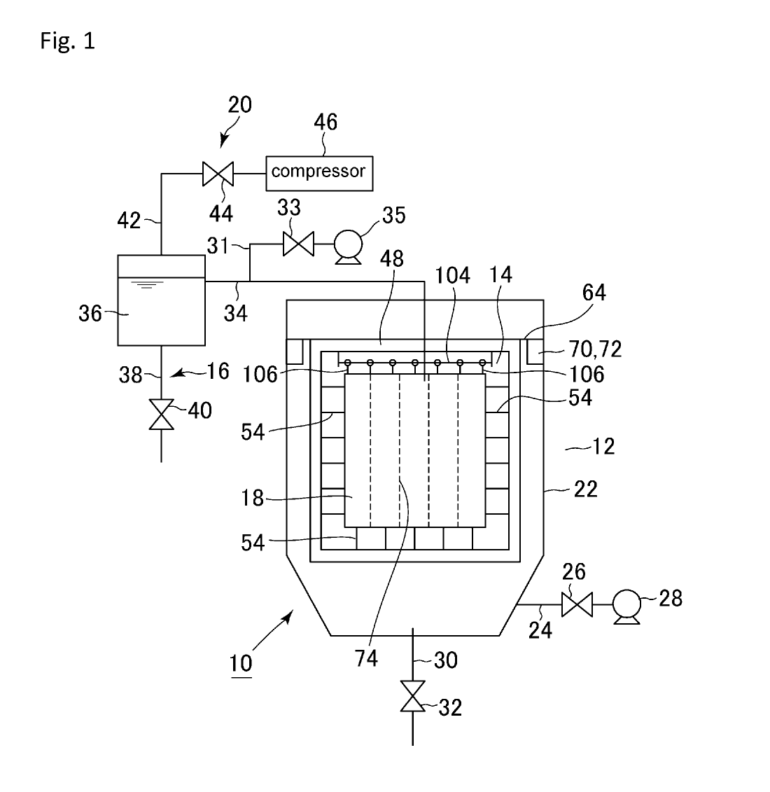

FIG. 2 is a general partial perspective view showing a situation in which a plurality of filtering plates are disposed to be adjacent from each other, in the filtering and condensing apparatus of the suction type in the first embodiment of the present invention.

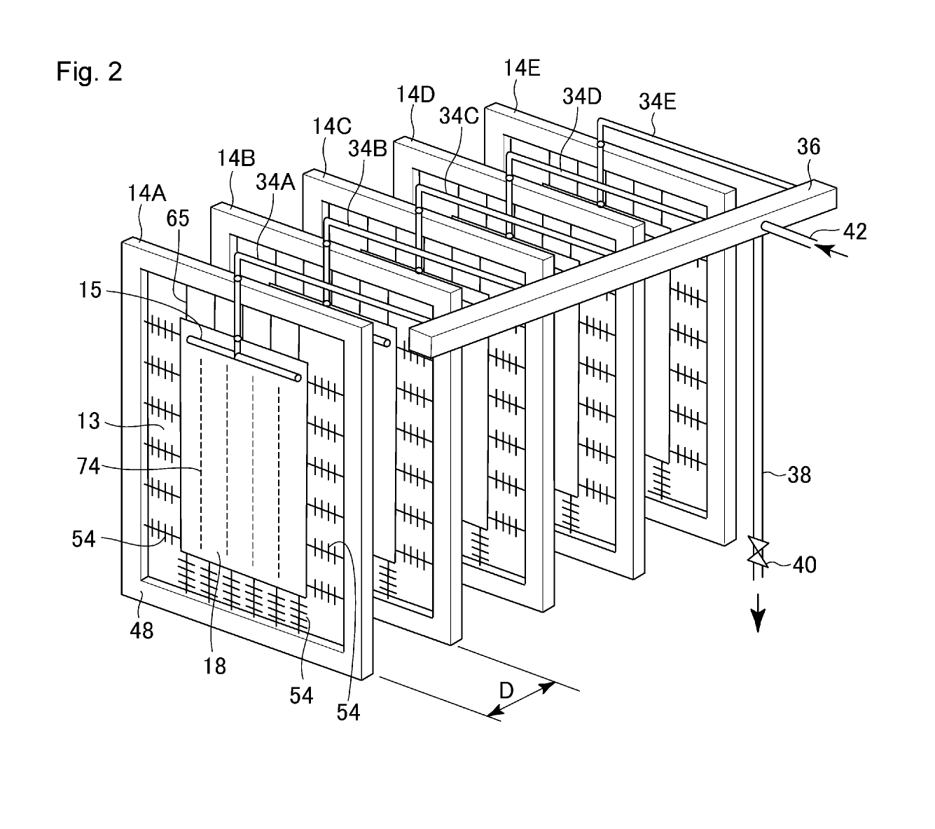

FIG. 3 is a general side view showing a filtering plate in the filtering and condensing apparatus of the suction type in the first embodiment of the present invention.

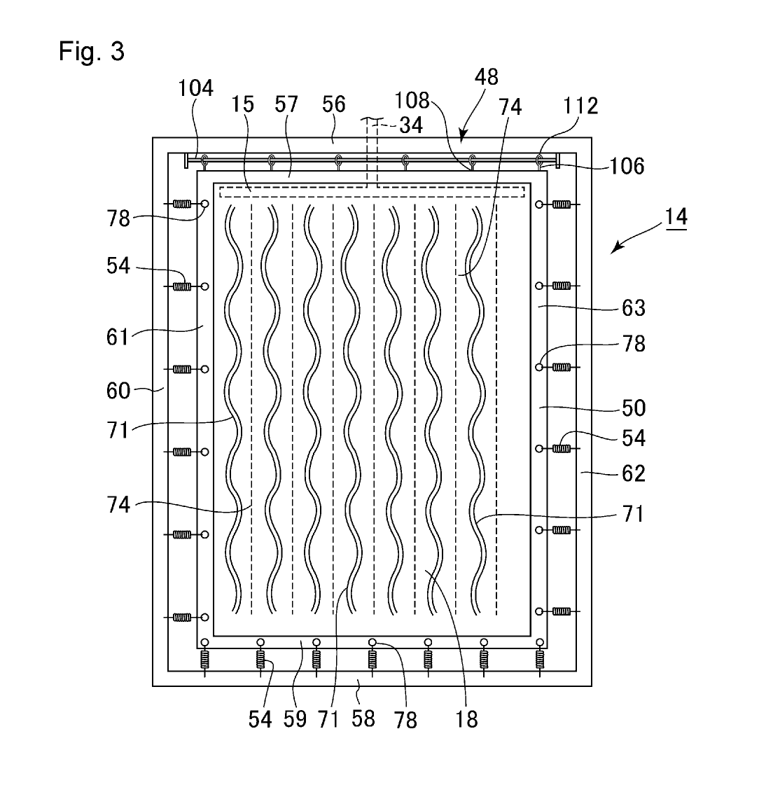

FIG. 4 is a partial plane view showing a situation in which a plurality of filtering plates are suspended and supported from the sludge tank, in the filtering and condensing apparatus of the suction type in the first embodiment of the present invention.

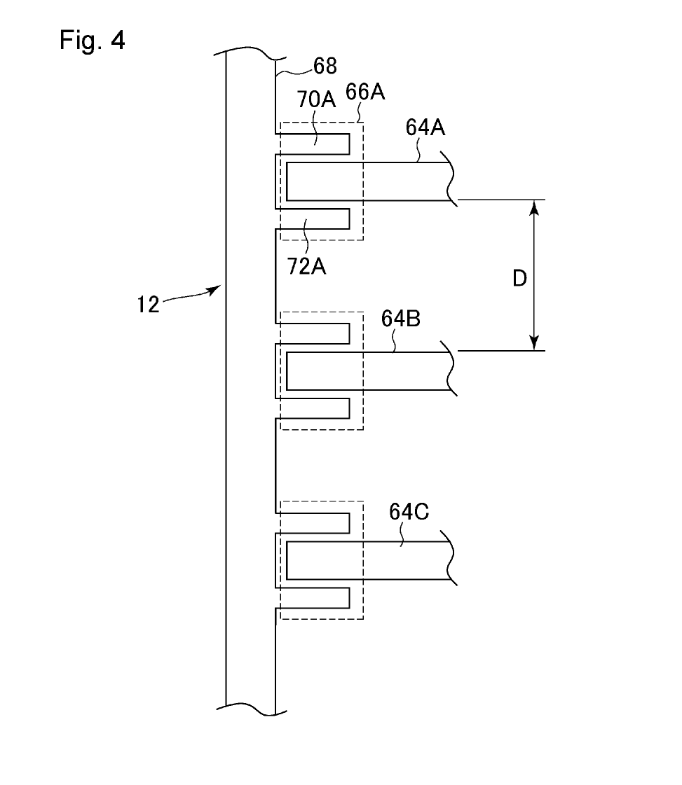

FIG. 5 (A) is a conceptual view showing a situation in which the filtering cloths of the adjacent filtering plates are expanded, and FIG. 5 (B) is a conceptual view showing a situation in which the filtering is carried out by the filtering cloths of the adjacent filtering plates, in the filtering and condensing apparatus of the suction type in the first embodiment of the present invention.

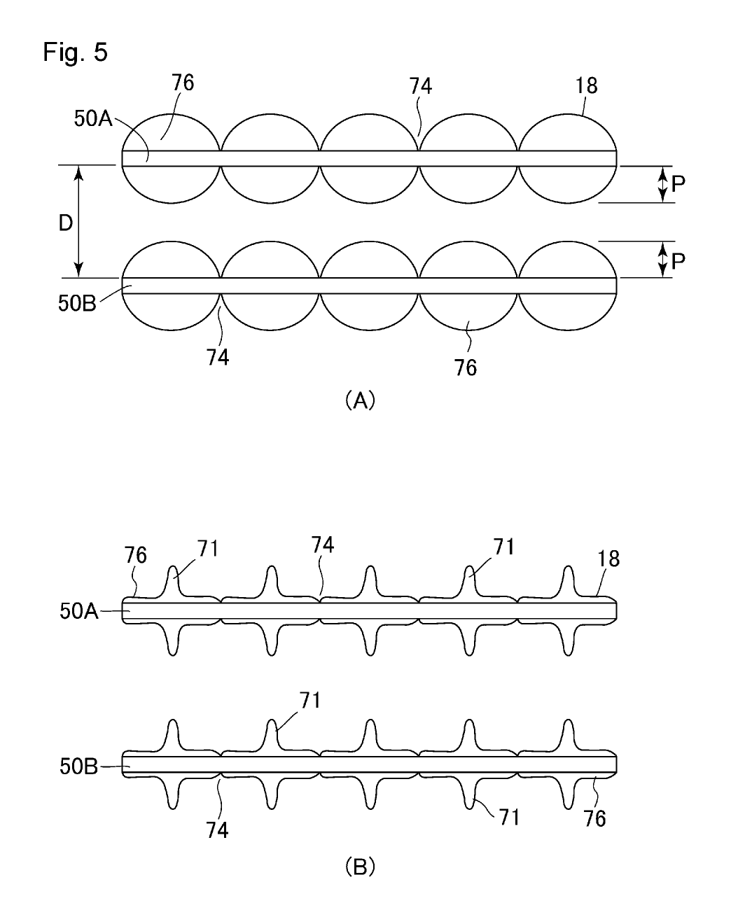

FIG. 6 is a general view showing a structure around the filtering plate in the filtering and condensing apparatus of the suction type in the first embodiment of the present invention.

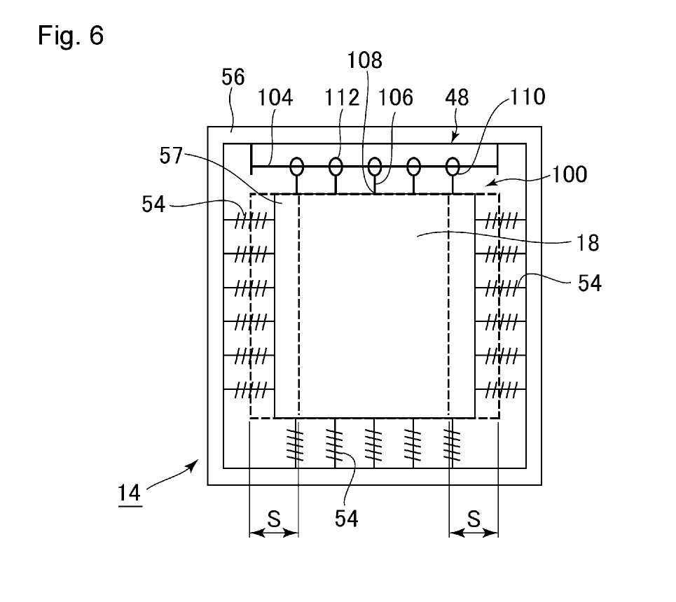

FIG. 7 is a view the same as FIG. 3 in the filtering and condensing apparatus of the suction type in the second embodiment of the present invention.

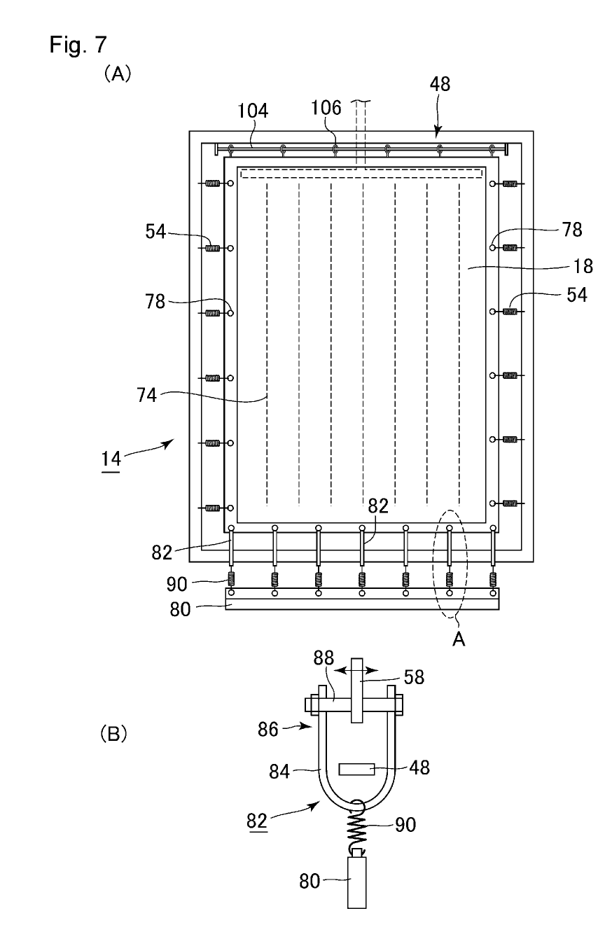

FIG. 8 is a view the same as FIG. 6 in the filtering and condensing apparatus of the suction type in the third embodiment of the present invention.

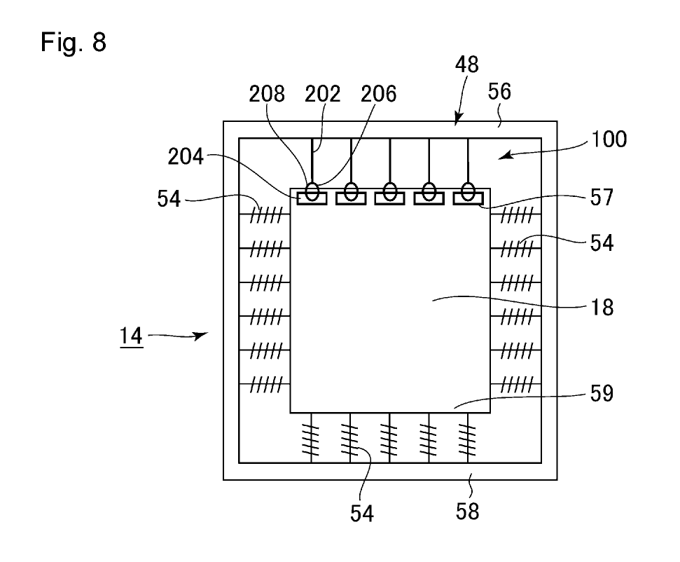

FIG. 9 is a view the same as FIG. 6 in the filtering and condensing apparatus of the suction type in the fourth embodiment of the present invention.

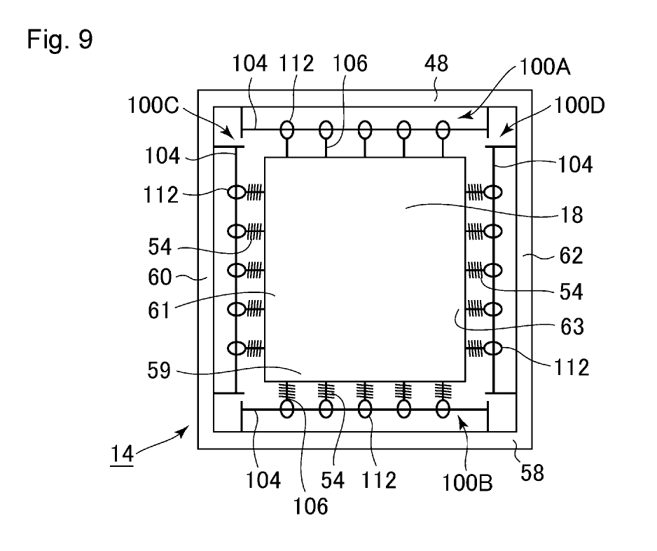

### EXPLANATION OF REFERENCE NUMBERS

P: amount of protrusion
D: distance
S: amount of displacement
10: filtering and condensing apparatus of suction type
12: sludge tank
14: filtering plate
15: horizontal tube
16: suction portion
18: filtering cloth
20: expanding portion
22: side wall
24: sludge supply/discharge tube
26: sludge supply/discharge valve
30: condensed sludge discharge tube
32: condensed sludge discharge valve
34: distribution tube
35: vacuum pump
36: filtrate storage tank
42: air supply tube
44: air supply valve
46: compressor
50: supporting plate
54: coil spring
56: upper side
58: lower side
60, 62: lateral side
71: non-adhering portion
74: seam
76: filtering chamber
78: eyelet
80: weight member
82: suspending fitting
84: extension
86: body
88: connecting rod
90: spring
100: sliding mechanism
104: guiding member
106: guided member
108: lower end
110: upper end
112: engaging portion
202: guiding member
204: guided member
206: lower end
208: engaging portion

What is claimed is:

1. A filtering and condensing apparatus of a suction type comprises a sludge tank for containing sludge to be filtered and condensed, and a plurality of filtering plates aligned with each other so as to be disposed to be adjacent to each other in the sludge tank, each plane portion of which extends in the vertical direction, each of the filtering plates includes a supporting plate in the form of a net, and a filtering cloth in a bag form so as to be integrally sewed on the supporting plate and to house said supporting plate, whereby a filtering chamber is formed inside the filtering cloth, and said apparatus further includes a means for sucking said filtering cloth through said filtering chamber, a means for expanding said filtering cloth through said filtering chamber, and a means for constantly applying a tension force to each of the filtering plates which is disposed to be over the periphery of each of the filtering plates, characterized in that a filtering frame for surrounding each of said filtering plates is provided on its outer periphery, said means for constantly applying a tension force provided between the lower side of the filtering frame and the lower side of said corresponding filtering plate consists of a vertically extending elastic member, a slide mechanism for moving said filtering plate in the lateral direction is provided between the upper side of the filtering frame and the upper side of the corresponding filtering plate, said sliding mechanism includes a means for limiting the vertical movement of the filtering plate.

2. The filtering and condensing apparatus of a suction type according to claim 1, said sliding mechanism includes a guiding member which is provided on the upper side of said filtering frame and extends in the lateral direction relative to the filtering frame and a guided member provided on the upper side of the corresponding filtering plate and laterally slidably engages said guiding member, said means for limiting the vertical movement is formed by said guided member engaging said guiding member.

3. The filtering and condensing apparatus of a suction type according to claim 2, said guiding member comprises a rail, said guided member includes a vertically extending engaging portion a lower end of which is fixed to said filtering plate and an upper end of which engages said rail.

4. The filtering and condensing apparatus of a suction type according to claim 2 or 3, said guided member comprises a plurality of guide members laterally spaced apart from each other with a predetermined distance.

5. The filtering and condensing apparatus of a suction type according to claim 3, said engaging portion comprises a ring into which said rail can be penetrated.

6. The filtering and condensing apparatus of a suction type according to claim 3, said engaging portion comprises a hook with a C-shaped cross section which can hook said rail.

7. The filtering and condensing apparatus of a suction type according to claim 1, said sliding mechanism includes a guiding member which is fixed to the upper side of said filtering frame and downwardly extends from the filtering frame, and a guided member which is provided on the upper side of the corresponding filtering plate and laterally slidably engages said guiding member.

8. The filtering and condensing apparatus of a suction type according to claim 7, said guided member comprises laterally prolonged eyelets provided on said filtering cloth, and an engaging portion engaging said eyelets is provided on the lower end of said guiding member.

9. The filtering and condensing apparatus of a suction type according to claim 8, said engaging portion comprises a ring which can engage said eyelets.

10. The filtering and condensing apparatus of a suction type according to claim 8, said engaging portion comprises a hook with a C-shaped cross section which can hook said eyelets.

11. The filtering and condensing apparatus of a suction type according to claim 8, further includes a sliding mechanism for laterally slidably moving said filtering plate is provided between the lower side of the filtering frame and the lower side of the corresponding filtering plate, said sliding mechanism includes a guiding member which is provided on the lower side of the filtering frame and laterally extends relative to the filtering frame, and a guided member which is provided on the lower side of the corresponding filtering plate and laterally slidably engages said guiding member, said guided member consists of said elastic member.

12. The filtering and condensing apparatus of a suction type according to claim 11, said guiding member comprises a rail, said guided member vertically extends and its upper end is fixed to said filtering plate, and includes at its lower end an engaging portion engaging said rail.

13. The filtering and condensing apparatus of a suction type according to claim 12, said engaging portion comprises a ring into which said rail can penetrate.

14. The filtering and condensing apparatus of a suction type according to claim 12, said engaging portion comprises a hook with a C-shaped cross section which can hook said rail.

15. The filtering and condensing apparatus of a suction type according to claim 1, said elastic member comprises a coil spring made of SUS.

16. The filtering and condensing apparatus of a suction type according to claim 1, a weight member is further mounted on the lower portion of said filtering cloth, whereby a tension force is downwardly applied to said filtering cloth due to its weight.

17. A filtering and condensing apparatus of a suction type comprising a filtering and condensing tank for containing a liquid including material to be filtered and condensed, and a plurality of filtering plates aligned with each other so as to be disposed to be adjacent to each other in the filtering and condensing tank, each plane portion of which extends in the vertical direction, each of the filtering plates includes a supporting plate in the form of a net, and a filtering cloth in a bag form so as to be integrally sewed on the supporting plate and to house said supporting plate, whereby a filtering chamber is formed inside the filtering cloth, and said apparatus further includes a means for sucking said filtering cloth through said filtering chamber, a means for expanding said filtering cloth through said filtering chamber, and a means for constantly applying a tension force to each of the filtering plates which is disposed to be over the periphery of each of the filtering plates, characterized in that a filtering frame for surrounding each of said filtering plates is provided on its outer periphery, said means for constantly applying a tension force provided between the lower side of the filtering frame and the lower side of said corresponding filtering plate consists of a vertically extending elastic member, a slide mechanism for moving said filtering plate in the lateral direction is provided between the upper side of the filtering frame and the upper side of the corresponding filtering plate, said sliding mechanism includes a means for limiting the vertical movement of the filtering plate.
